(19) United States
(12) Patent Application Publication
(10) Pub. No.: US 2023/0390805 A1
(43) Pub. Date: Dec. 7, 2023

(54) IMPROVEMENTS IN SCREENING PANELS

(71) Applicant: Schenck Process Australia Pty Limited, North Ryde NSW (AU)

(72) Inventor: Aidan Paul JOHNSTONE, North Ryde (AU)

(21) Appl. No.: 18/041,869

(22) PCT Filed: Aug. 13, 2021
(86) PCT No.: PCT/AU2021/050893

§ 371 Date: Feb. 16, 2023

(30) Foreign Application Priority Data
Aug. 19, 2020 (AU) 2020902955

(51) Int. Cl. B07B 1/46; B29C 45/14

(52) U.S. Cl. CPC B07B 1/4645; B29C 45/14819; B07B 1/4618

(57) ABSTRACT

Panel member assembly (10, 11, 60, 80, 100, 130) for use as a screening panel in a vibratory screening machine for treatment of mining materials either as an impact panel member or as a sieving panel member. The assembly has an engagement face (12, 105) for engagement during use with treatment material. The assembly also has a support structure (23, 102, 131) with a first side (26) directed towards the engagement face. The first side defines a plurality of spaced receiving zones (29, 129, 138) each being configured to locate an individual hard wear resistant insert (21, 101, 136, 137). The assembly also has a plurality of the inserts respectively located in a receiving zone with part of the inserts extending towards the engagement face. The support structure and located inserts are retained in a moulded cover material (24).

### FIELD OF THE INVENTION

This invention relates to screening panels including modular constructed screening panels utilised in vibratory screening machines of the type used in mining and quarrying activities.

### BACKGROUND TO THE INVENTION

Screening is widely used in mining and quarrying industries, to separate crushed ore into grades with a consistent and specific particle size range. Screening panels and machinery for using same may also be used for comparable purposes in other industries.

Screening panels may generally be of the impact type which don't have apertures to pass screened material therethrough and also those having apertures to pass screened material of a particular size range therethrough. Often impact screen panels are positioned as a first structure in an array of screening panels with apertured screening panels receiving material from the impact screen panel or panels. It is also known to provide modular screening systems where a screening panel is made up of replaceable modular panel elements (typically made of rubber or other elastomeric material including polyurethane covering a steel frame) in an array secured to an underlying support frame structure. Wear deterioration on screen panels tends to be localised and modular screening panel configurations allow one or several modular elements to be replaced, when required, without having to replace the whole screen panel. Australian Patent Specification 482212 discloses such a modular screening system.

It will be understood that such screening panels operate in difficult environments and suffer substantial wear rates. It is of course recognised that extending the time periods between the stages of replacement (or partial replacement) of the panels or panel elements, is highly desirable. A still further desirable attribute is to assist operators being able to detect easily when a panel or panel element wear rate has progressed to a stage where the panel or panel element should be replaced. Patent Specification Nos WO2013/026090 and WO2002/074453 disclose configurations utilised in screening panels for identifying when wear rates have progressed to a stage where replacement or partial replacement should occur.

To increase wear life of screening panels, and effectiveness in use, it is known also to include hard but light weight ceramic elements in the panel structure. For example Patent Specification No WO2017/109575 discloses an impact modular panel for a screening deck which includes an impact surface of an alumina ceramic tile bonded by adhesive to a metal support.

### OBJECTIVE OF THE INVENTION

An objective of the present specification is to increase the wear life of screening panels or modular elements used in such screening panels, preferably in both impact type panels and sieving type panels, while preferably also providing ease of recognising wear indication levels.

In particular an objective is to provide a clear visual indicator of wear levels in such screening panels or screening modular panel elements.

### SUMMARY OF THE INVENTION

According to a first aspect of this disclosure there is provided a panel member assembly being a screening or impact panel or screening or impact panel module element having an engagement face for engagement with treatment material in use, said panel member assembly further having at least one unitary reinforcing support structure with a first side directed towards said engagement face, said first side defining a receiving zone or zones, the or each said receiving zone being configured to locate an individual hard wear resistant insert, a said hard wear resistant insert located in the or two or more of said receiving zones with at least a portion of the or each said hard wear resistant insert extending towards said engagement face, and a mouldable cover material moulded to said support structure and to said hard wear resistant insert or inserts whereby said mouldable cover material forms, at least in part, said engagement face, while securing said hard wear resistant insert or inserts to said support structure.

In a second preferred aspect, the present disclosure provides a panel member assembly being a screening or impact panel, or a screening or impact panel module element, that together with other screening or impact panel module elements form a screening or impact deck, the panel member assembly having an engagement face for engagement with treatment material in use, said panel member assembly further having at least one reinforcing unitary support structure with a first face directed towards said engagement face, said first face defining a receiving zone or discrete spaced receiving zones, the or each said receiving zone being configured to locate and hold an individual hard wear resistant insert, said hard wear resistant insert being located and held in the or at least one of said receiving zones with at least a portion of the or each said hard wear resistant insert extending from the first face of the support structure towards the engagement face of the panel member assembly, and a mouldable cover material moulded to said support structure and to the or each said hard wear resistant insert whereby said mouldable cover material forms, at least in part, said engagement face, while securing said hard wear resistant insert or inserts to said support structure.

Conveniently, the or each said hard wear resistant insert has a first upper surface region facing towards or forming part of said engagement face, a second lower surface region facing away from said engagement face, and a third intermediate side surface region or regions, connecting said first upper and said second lower surface regions, the or each said unitary reinforcing support structure being sufficiently open to permit said mouldable cover material to be moulded to and bond a substantial portion of said second lower surface region and at least part of said side surface region or regions of the or each of said hard wear resistant insert to the or one of a said unitary reinforcing support structure. In some preferred embodiments, at least some or all of the or each said hard wear resistant insert(s) is substantially fully surrounded by and bonded to said mouldable cover material.

The panel member assembly has a second lower face opposed to said engagement face and a plurality of side edge faces connecting the second lower face to the engagement face, said engagement face and said second lower face providing continuous surfaces when the panel member assembly is an impact type panel member, and the engagement face has spaced screening openings passing through the panel member assembly opening through the second lower face when the panel is a sieve type screening panel member. The interior of the panel member assembly is solid except for the screening openings when provided, that is, filled by a combination of the mouldable cover material surrounding the hard wear resistant insert(s) and the unitary reinforcing support structure.

Preferably the or each said receiving zone is configured whereby a lower region of the or each said receiving zone is substantially open except for first engagement means adapted to engage the hard wear resistant insert located in the receiving zone whereby said first engagement means prevents the engaged hard wear resistant insert from moving in a direction away from said engagement face.

In another preferred arrangement, some or all of said receiving zone(s) include second engagement means cooperating with a said hard wear resistant insert located in said receiving zone to prevent lateral movement of said hard wear resistant insert in a direction parallel to said engagement face. Still further it is preferred that the or each said unitary reinforcing support structure includes spaced openings configured to allow flow of said mouldable cover material along surfaces of the each said hard wear resistant insert towards the second lower surface region of the or each said hard wear resistant insert

According to a particularly preferred embodiment, the or each said support structure includes a plate section facing towards the engagement face, the or each said receiving zone being formed by a location aperture in said plate section. Preferably, a said first engagement section or sections is formed by a wall or edge portion or portions of a said location aperture. In one possible arrangement, the location aperture might be a generally polygonal shape, for example, square, rectangular, pentagonal, hexagonal, octagonal, with the cross-section of the hard wear resistant inserts being similarly or differently polygonal in cross-section but of smaller transverse dimension whereby flat zones of the polygonal configuration of the location apertures provide first engagement sections for corners of the hard wear resistant inserts. Another possible arrangement is to provide circular location apertures with the hard wear resistant inserts having a transverse polygonal shape whereby corners of the inserts engage the first engagement section being a region of the circular edge or surface of the location aperture. These possible preferred arrangements provide a gap zone between most of the location aperture in the plate section and surfaces of the hard wear resistant insert whereby the mouldable cover material can flow through such that it can be positioned above and below the plate section and also within the aforesaid gap zones to bond the hard wear resistant insert to the plate section. The arrangement thus provides a convenient method of construction while also supporting and cushioning the hard wear inserts when the panel member assembly is used.

In a still further preferred construction, the support structure may include a plate section facing towards the engagement face and being located in a plane generally parallel to said engagement face, the or each said hard wear resistant insert is located in a said receiving zone with a first end region facing towards or forming part of said engagement face and have a second end region opposed to said first end region, said second end region extending beyond a second side of said plate section opposed to said first side of said support structure. Conveniently in a preferred design arrangement, a bar, rod or strip member may be located beneath the or each said location aperture, bar, rod or strip member forming part of a said support structure.

In another preferred construction arrangement, the support structure may include at least a first plate section and a second plate section laterally spaced from one another, each of said first and said second plate sections having a lateral disposition relative to said engagement face whereby an edge region of said first and said second plate sections form part of said engagement face or face towards said engagement face, a said receiving zone or zones being formed in each said first and said second plate section whereby a said hard wear resistant insert formed as an elongated member extends at least between a selected said receiving zone in each of said first plate section and said second plate section. Conveniently, multiple said elongated members may be provided. The aforesaid elongated member or members may be positioned generally parallel to the engagement face. Preferably at least two said elongated members are positioned at different distances (or depths) from the engagement face. It is likely that multiple said elongated members may be provided in separate layers with each layer being located at different depths from the engagement face. While two spaced plate sections are referred to in the foregoing, depending on the size of the panel member assembly, more than two spaced plate sections may be provided.

In a preferred design, the or at least one of said elongated member(s) may have a cross-sectional shape that dimensionally increases in a direction away from a portion located as part of the engagement face or faces toward the engagement face. Conveniently the or at least one said elongated member has a maximum cross-sectional dimension at a mid distance from said engagement face and cross-sectionally converges in from said maximum cross-sectional dimension in a direction away from said engagement face.

In relation to the foregoing, one preferred aspect of this disclosure provides a panel member assembly being a screening or impact panel or screening or impact panel module element having an engagement face for engagement with treatment material in use, said panel member assembly further having at least one unitary reinforcing support structure with a first side directed towards said engagement face, said first side defining a receiving zone or zones, the or each said receiving zone being configured to locate an individual hard wear resistant insert, a said hard wear resistant insert located in the or two or more of said receiving zones with at least a portion of the or each said hard wear resistant insert extending towards said engagement face, and a mouldable cover material moulded to said support structure and to said hard wear resistant insert or inserts whereby said mouldable cover material forms, at least in part, said engagement face, while securing said hard wear resistant insert or inserts to said support structure, said support structure including at least a first plate section and a second plate section a laterally spaced from one another, each of said first and said second plate sections having a lateral disposition relative to said engagement face whereby an edge region of said first and said second plate sections form part of said engagement face or face towards said engagement face, a said receiving zone or zones being formed in each said first and said second plate section whereby a said hard wear resistant insert formed as an elongated member extends at least between a selected said receiving zone in each of said first plate section and said second plate section.

In a further possible preferred construction, the panel member assembly may include a single said hard wear resistant insert that engages with said support structure, said single hard wear resistant surface having a wear engagement surface positioned adjacent to or forming part of said engagement face. Conveniently, in this construction, the support structure may include spaced lateral edge plate means connected to one another at a location spaced from said engagement face by a connecting wall formation means, said spaced lateral edge means defining a said receiving zone, said single hard wear resistant insert having a plate section defining on one face said wear engagement surface and on an opposed face, spaced downwardly depending location formations engageable respectively with one of said spaced lateral edge plate means. Preferably, the cover material may be moulded to said single hard wear resistant insert and said support structure whereby said mouldable cover material forms at least part of the engagement face, all side edge faces and a lower face opposed to said engagement face of said panel member assembly, said mouldable cover material substantially filling a space between said opposed face of the plate section of said hard wear resistant insert and said connecting wall formation means.

Preferably, peripheral edge regions of the wear engagement surface of the single hard wear resistant insert are chamfered or recessed to be filled by said mouldable cover material in the panel member assembly. The plate section of the single hard wear resistant insert may include positioning means (eg a recess or bore) to receive a spacing member or members to space the plate section of the insert from the connecting wall formation means. The spacing members may be formed by rod or dowel members made from a rubber or elastomeric material, preferably of a harder consistency, the rubber or elastomeric material providing a better bond with the mouldable cover material that will fill the space between the plate section of the insert and the connecting wall formation means of the support structure.

In the above discussed embodiment, the panel member assembly may be a screening or impact panel or screening or impact panel module element with an engagement face for engagement with treatment material in use, said panel member assembly further having at least one unitary reinforcing support structure with a first side directed towards said engagement face, said first side defining a receiving zone configured to locate a single individual hard wear resistant insert, said hard wear resistant insert being located in the receiving zone with at least a portion of said hard wear resistant insert extending towards said engagement face, and a mouldable cover material moulded to said support structure and to said single hard wear resistant insert whereby said mouldable cover material forms, at least in part, said engagement face, while securing said single hard wear resistant insert to said support structure.

In yet another preferred construction the support structure may have flow apertures to permit said mouldable cover material to flow through panel member assembly to form the or at least part of the engagement face, a second opposed face of the panel member assembly, and to at least partially surround and bond to the or each said hard wear resistant insert. The support structure may include an upper plate section through which the flow apertures are positioned. It will, however be recognised that the support structure may have other constructions not including a plate section.

Conveniently, in another preferred arrangement, the support structure includes a plurality of second apertures in a defined array, said second apertures extending fully through the panel member assembly to act as screening apertures for passage of particulate material, in use, of the panel member assembly.

In yet another preferred embodiment, the present disclosure provides a panel member assembly being a screening or impact panel, or a screening or impact panel module element, that together with other screening or impact panel module elements form a screening or impact deck, the panel member assembly having an engagement face for engagement with treatment material in use, said panel member assembly further having a unitary reinforcing support structure with at least one plate section, the or each said plate section having at least one location aperture extending through said plate section, the or each said location aperture forming a receiving zone or discrete spaced receiving zones to locate and hold an individual hard wear resistant insert, a said hard wear resistant insert being located in the or at least some of said receiving zones with at least a portion of the or each said hard wear resistant insert facing towards the engagement face of the panel member assembly, the or each said hard wear resistant insert having an engagement portion or portions engageable with an edge zone of a said location aperture, and a mouldable cover material moulded to said unitary reinforcing support structure and to the or each said hard wear resistant insert whereby said mouldable cover material forms, at least in part, said engagement face, said unitary reinforcing support structure being sufficiently open to provide flow zone(s) for said mouldable cover material to flow either between a said hard wear resistant insert and an edge zone of a said location aperture or extending through said plate section outwardly of and adjacent to a said location aperture whereby said mouldable cover material bonds to and secures at least a lower region of a said hard wear resistant insert to said unitary reinforcing support structure.

The mouldable cover material may be a natural or synthetic rubber compound or composition or some other elastomeric material including elastomeric polymer materials. These may include polyurethane or ultrahigh molecular weight polyethylene (UHMWPE). The mouldable cover material may fully form the engagement face or alternatively, the hard wear resistant inserts may have portions forming part of the engagement face. The engagement face may be substantially planar or may have a non-planar configuration such as an adjacent raised bar configuration separated by valleys or gutters. In still another possible configuration the engagement face may follow a shape defined by the hard wear resistant inserts extending from the support structure and may be fully formed by the moulded cover material or only in part thereby.

In a preferred embodiment, where the support structure may include a plate section with location apertures forming each of the insert receiving zones, the plate section, at least, may be made from or include any of mild steel, alloy steel, chrome carbide steel, tungsten carbide steel, nickel carbide steel, white cast iron alloys with nickel/chromium, polyamide and/or ultra high molecular weight polyethylene (UHMWPE). The plate section or any other part of the support structure may include a base mild steel layer with a hard material surface coating or layer forming at least part of the first side of the support structure.

The hard wear resistant inserts are preferably made from materials that include ceramics, chrome carbide, tungsten carbide or nickel carbide. The inserts conveniently are light weight to lower the overall weight of the assembly but provide reinforcing strength and wear resistance for the assembly. In one configuration, each hard wear resistant insert may have a cross-sectional shape that is uniform along its length with the cross-sectional shape being selected from square, rectangular, polygonal, circular or oval. In another possible preferred configuration, the insert may have a portion of decreasing cross-sectional size towards the engagement face. The portion of decreasing cross-sectional size may be pyramidal, conical of frusto-conical.

Conveniently, the panel member assembly may include a second face opposite to the engagement face, the second face also being formed by the mouldable cover material, the mouldable cover material extending from the engagement face to the second face through the panel member assembly. Preferably, the panel member assembly is manufactured by injection moulding of the cover material onto the support structure carrying the hard wear resistant inserts. In alternative preferred manufacture processes, compression moulding, air casting or any other process might be used to mould the cover material onto the support structure.

Preferably, the panel member assembly as disclosed herein will be formed as a screening panel module element suitably configured so as to be mounted to a sub frame of a screening machine in combination with other screening panel module elements such that the modular elements together form a screening panel. This arrangement allows the individual elements to be selectably replaced when wear rates dictate that they should. While such arrangements are preferred, there is no reason why a single complete screening panel member could not be produced and used in accordance with the disclosure contained in this specification.

The cover material forming part of the panel member assembly will normally include a degree of elasticity and will provide not only bonding and securing of the hard wear resistant inserts to the underlying structure but also provide a degree of cushioning effect which is useful during use of the panel member assemblies. During use, the cover material will wear, as will the hard wear resistant inserts (although at a slower rate) such that uncovered inserts will provide a wear indicator, particularly where the inserts have a progressively increasing cross-section the closer the wear occurs towards the support structure. Other forms of wear level indication could also be moulded directly into the cover material during manufacturing of the panel member assembly.

In accordance with another preferred aspect, the present disclosure provides a method of constructing a panel member assembly being a screening or impact panel, or a screening or impact panel module element that together with other screening or impact panel module elements form a screening or impact deck having an upper engagement face for engaging treatment material, said method including steps of:
fabricating a unitary reinforcing support structure with a first face and a second opposed face, said support structure defining a receiving zone, or a plurality of spaced receiving zones, the or each said receiving zone being configured to locate and hold an individual hard wear resistant insert;
positioning a said individual hard wear resistant insert in the or at least some of said receiving zones whereby the or each said hard wear resistant insert is partially located within said unitary reinforcing support structure; and
moulding a mouldable cover material to said hard wear resistant insert or inserts positioned in and held by said unitary reinforcing support structure whereby said mouldable cover material secures the or each said hard wear resistant insert to said unitary reinforcing support structure, said mouldable cover material forming at least part of said upper engagement face spaced above said first face of said unitary reinforcing support structure and passing through and encasing said unitary reinforcing support structure to form a second surface below the second opposed face of said unitary reinforcing support structure.

In a number of above described preferred aspect embodiments, the receiving zones for individual hard wear resistant inserts are formed in a plate section of the support structure where the inserts or a portion thereof held by the receiving zones extend towards the engagement face of the panel member assembly. In these embodiments the receiving zones are apertures or openings in the plate section and in various preferred embodiments, these apertures or openings have open areas spaced from the held insert although some parts of the insert remain in contact with and are held by the plate section. These spaces may be filled by the mouldable cover material during the cover material moulding process. Or, in a possible variation, may be at least partially filled by a harder, stiffer quality rubber or elastomeric material prior to moulding the cover material. In one preferred method a strip or sheet of high stiffness rubber or elastomeric material is laid over the receiving zone openings in the plate section and hard wear resistant inserts are knocked downwards into the receiving zone apertures thereby wedging a portion of the higher stiffness rubber or elastomeric material into the receiving zone opening. This process provides a better securing and holding of the hard wear resistant inserts into the receiving zones, and a better connection/bonding with the cover material when moulded as the wedged strip material is a rubber or elastomeric compound.

Preferably, the or each said hard wear resistant insert has a first upper end or face extending from the first face of the unitary reinforcing support structure and a second lower end or face, the first upper end or face being connected to the lower end or face by one or more connecting faces, said unitary reinforcing support structure being an open construction whereby said mouldable cover material is moulded to at least a portion or portions of the second lower end or face and the connecting face or faces extending therefrom of the or each said hard wear resistant insert. Conveniently the engagement face may be either planar or non-planar. The engagement face may be formed solely by the mouldable cover material or may include a portion or portions of the or at least some of the hard wear resistant inserts surrounded by the mouldable cover material.

In the aforementioned method of construction, moulding of the mouldable cover material may occur by any of injection moulding, compression moulding, or air cast moulding onto the support structure carrying said hard wear resistant insert or inserts.

Advantages that may be achieved by carrying out aspects of this disclosure include:
superior fixing of the hard wearing insert or inserts preventing dislodgement of the insert or inserts from the panel assembly during use;
improved cushioning of the hard wear resistant insert(s) to minimise cracking and other damage to such inserts;
superior wear monitoring due to shape configurations of the hard wear resistant insert(s) and to the multiple layer designs; and
potential weight savings with the unitary reinforcing support structure also being a wear member part and that the hard wear resistant inserts are also quite light weight.

It will be understood that terms such as “comprises”, “comprising”, “includes” and/or “including” when used herein, specify the presence of stated features, items, steps, operations, elements and/or components, but do not preclude the presence or addition of one or more other features, items, steps, operations, elements, compounds and/or groups thereof.

Various objects, features, aspects and advantages of the subject matter of this disclosure will become apparent from the following detailed description of preferred embodiments illustrated in the accompanying drawings.

### BRIEF DESCRIPTION OF THE DRAWINGS

FIG. 1 is a perspective view of a first preferred embodiment of a modular screening panel element as disclosed herein;

FIG. 2 is a perspective view of a possible modular screening panel element as disclosed herein after panel wear indicating how the embedded wear resistant inserts are used as a wear indicator;

FIG. 3 illustrates in perspective view the support structure and hard wear resistant insert array employed in the embodiments of FIGS. 1 and 2;

FIG. 4 illustrates a possible view of the embodiments of FIGS. 1/2 after a period of use whereby wear results in hard facing metal being exposed;

FIG. 5 is a perspective view similar to FIG. 3 illustrating an alternative configuration of the hard wear resistant inserts;

FIG. 5a is a partial plan view of a hard wear resistant insert positioned in a location aperture as represented in FIG. 5;

FIG. 6 is a view similar to FIG. 5 showing a possible alternative configuration for the hard wear resistant inserts;

FIG. 6a is a view similar to FIG. 5a showing a hard wear resistant insert utilised in FIG. 6;

FIG. 7 is a perspective view of a third preferred embodiment of a modular screening panel element as disclosed herein;

FIG. 8 is a perspective view of the support structure and hard wear resistant inserts utilised in the embodiment of FIG. 7;

FIG. 9 is a plan view of the partial assembly shown in FIG. 8;

FIG. 10 is a perspective view of a fourth preferred embodiment of a modular screening panel element as disclosed herein of the material sieving type where material flow apertures pass through the structure;

FIG. 11 is a section perspective view through a mid plane of the modular screening panel element assuming even wear of the treatment material engagement face;

FIG. 12 is a view similar to FIG. 11 showing the upper surface worn down to the upper face of the internal support structure;

FIG. 13 is a perspective view of the internal support structure of the modular screening panel element shown in FIGS. 10 to 12;

FIG. 14 is a plan view of the internal support structure shown in FIG. 13;

FIG. 15 is a perspective view of a further preferred embodiment of a panel member assembly utilising a single hard wear resistant insert;

FIG. 16 is a perspective view similar to FIG. 15 but with half of the moulded cover material removed to reveal some aspects of the panel member assembly;

FIG. 17 is an underneath perspective view of the single hard wear resistant insert utilised in FIG. 15;

FIG. 18 is an end elevation view of FIG. 16;

FIG. 19 is a perspective view of a panel member assembly of a still further preferred embodiment;

FIG. 20 is a view of FIG. 19 with a portion of the moulded cover material removed to show some of the internal features;

FIG. 20a is a partial section view along line A-A of FIG. 20;

FIG. 21 is a view similar to FIG. 20 but showing a still further alternative preferred embodiment;

FIG. 21a is a partial section view along line A-A of FIG. 21; and

FIG. 22 is a view similar to FIG. 21 but with further cover material removed to reveal further possible internal features of the assembly.

### DESCRIPTION OF THE PREFERRED EMBODIMENTS

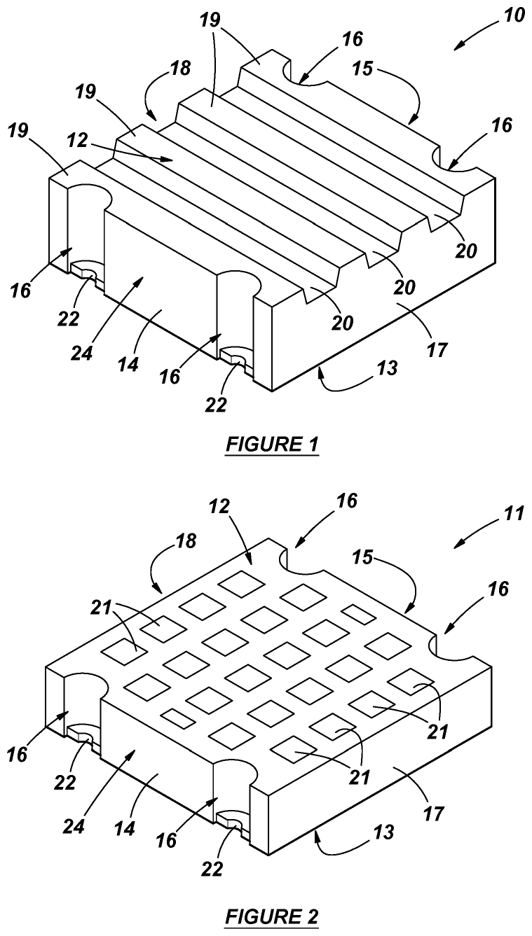

Referring to FIGS. 1 and 2, a preferred embodiment of a panel member assembly module element 10, 11 is illustrated having an upper treatment material engagement face 12, a lower or opposite second face 13, a first pair of opposed side faces 14, 15 defining spaced fixing mount means 16, and a second pair of opposed side faces 17, 18. The fixing mount means 16 enable the panel member assembly 10, 11 to be releasably mounted to a vibratory sub frame or similar as is well known in the prior art and will not be further described in this specification. In relation to this aspect so much of the prior art disclosures is incorporated herein for a proper understanding of this disclosure. The preferred embodiment shown in in FIG. 1 includes raised and spaced bars 19 separated by valleys or gutters 20. FIG. 2 illustrates where the engagement face 12 is substantially planar but where an array of hard wear resistant inserts 21 can be seen as forming part of the engagement face 12. In this configuration, visual sighting of the inserts 21 can be used as a visual indication of wear that may dictate replacement of the panel member assembly 10, 11. It should be recognised that the upper or engagement face of the module element may have other shapes including a substantially planar surface and the hard wear resistant inserts 21 may form part of this surface (for example, as depicted in FIG. 2), or be covered by the cover material as shown in FIG. 1. Details of the inner structure of the panel member assembly 10, 11 will be described in greater detail hereafter. The half circular fittings 22 forming part of the fixing mount means 16 are part of a support structure 23 forming part of the inner structure. The body of the panel member assembly 10, 11 illustrated generally in FIGS. 1 and 2 (other than the fittings 22 and inserts 21) is formed by a cover material 24 moulded, conveniently by injection moulding techniques, as described previously, to the support structure 23.

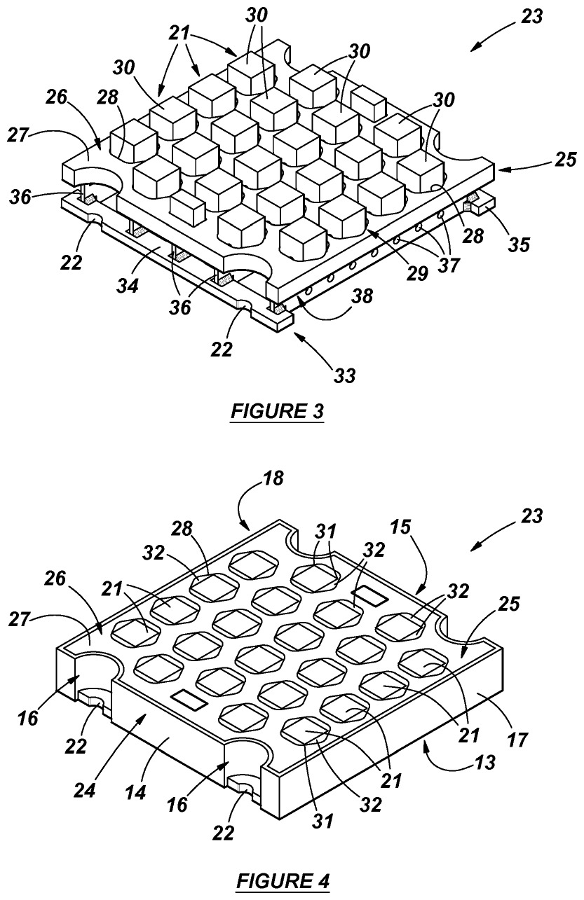

FIG. 3 illustrates the support structure 23 with installed hard wear resistant inserts 21 forming an inner portion of the panel member assembly 10, 11 (FIGS. 1, 2). The support structure 23 has a plate section 25 with a first side 26 having an upper surface 27, and a lower surface 38, the plate section 25 having a plurality of spaced apertures 28, defining a receiving zone 29 for receiving and locating a respective one of the hard wear resistant inserts 21. In this embodiment each hard wear resistant insert 21 has a square cross-sectional shape that is uniform along its length from a free upper end 30 to a lower end contained within the receiving zones 29. The shape of the hard wear resistant inserts 21 may, however, be variable as described earlier and as shown in later described drawings. The apertures 28 forming the receiving zones 29 for location of a respective insert may have a hexagonal shape whereby corners 31 of respective inserts 21 engage a face of the hexagon recess as shown leaving recessed free zones 32 around the insert 21 that can be filled by the moulded cover material forming the body 24 (FIG. 1). A fabricated sub structure 33 is positioned below the plate section 25 having side bars 34, 35 in which the half circular fittings 22 are formed and cross support plates 36 secured to the side bars 34, 35 and the under surface of the plate section 25. A plurality of spaced rod members 37 extend across the support structure 23 engaging the lower surface 38 of the plate section 25 and traversing the apertures 28 to provide a lower stop or support for the lower end of the hard wear resistant inserts 21. It will of course be appreciated by those skilled in the art that many other structures or methods may be used to provide a lower stop or support for the lower ends of the inserts 21. FIG. 4 illustrates an embodiment such as shown in FIGS. 1, 3 sectioned or worn down to the level of the upper surface 27 of the plate section 25.

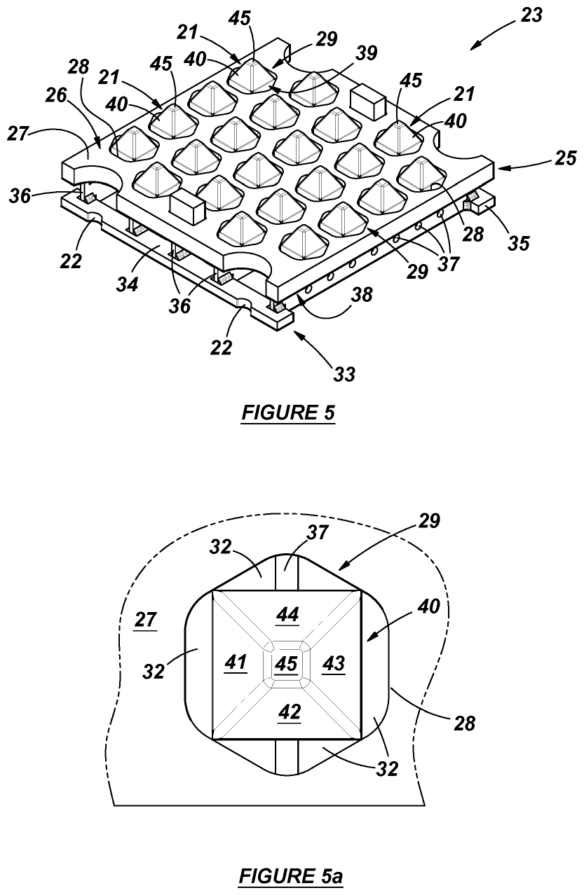

FIGS. 5 and 5a illustrate a support structure 23 similar to that shown in FIG. 3 but utilising a different form of hard wear resistant insert 21. Like features described above in relation to FIGS. 3 and 4 have been given the same reference numbers and are not further described here. In this preferred embodiment, the hard wear resistant inserts 21 have a base section 39 that has a rectangular/square cross-section that engages in the receiving zone 29 in a similar manner to the insert 21 shown in FIG. 3. The upper portion 40 of each insert 21 extending away from the surface 27 of the plate section 25 has a pyramidal shape with four surfaces 41, 42, 43 and 44 angled or tapering towards the free upper end 45. In this manner, from the base section 39 to the free upper end 45, the cross-sectional shape of the insert 21 progressively decreases. While the drawing shows a portion 40 where the cross-section decreases at a constant rate, it is of course possible to configure the portion 40 whereby the cross-section decrease changes at a variable rate, i.e. quicker towards the upper end rather than at the end zone closer to the base section 39. Another possible variation might be to extend the square or rectangular base section upwardly to a position intermediate the surface 27 of the plate section 25 and the free upper end 45.

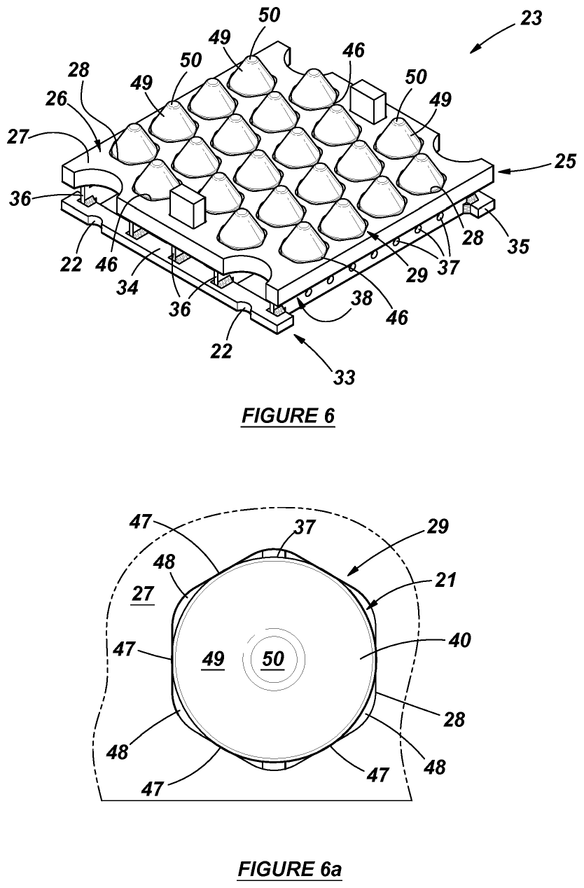

FIGS. 6 and 6a also illustrate a support structure 23 similar to that shown in FIGS. 3 and 5, but utilising a still further different form of hard wear resistant insert 21. Again, like features described above in relation to FIGS. 3 to 5a have been given the same reference numbers and are not further described here. In this preferred embodiment, the hard wear resistant inserts have a base section 46 that is cylindrically formed with a uniform circular cross-section. The peripheral surface of the base section 46 engages surfaces of the hexagonal shaped apertures 28 forming the receiving zones 29 and further a lower end surface of the base section 46 sits in the rod member 37. While the base section 46 of the inserts 21 engage the plate section 27 at contact locations 47, spaces 48 also surround the base section 46 to allow the cover material 24 forming the body to be moulded therein. The upper or outwardly extending region 49 of the hard wear resistant insert 21 is conical or frusto-conical shaped to a free end 50. The conical section of the regions 49 might commence at the surface 27 of the plate section 25 or at a short distance spaced outwardly therefrom. While the drawing illustrates a uniform cross-sectional reduction in the conical section, as with the embodiment of FIG. 5, this rate of cross-sectional reduction towards the free end 50 might also be variable.

It will be appreciated that the variable cross-sectional size of the hard wear resistant inserts 21 as depicted, for example, in FIGS. 5, 6, will be seen as a progressively increasing surface area (as seen in FIG. 2) as the panel member assembly 10, 11 wears. This increasing surface area of the insert 21 in the engagement face of the panel member assembly 10, 11 can be used as a limit wear indicator to indicate when a panel member assembly 10, 11 needs to be replaced. Of course, other indicator means might be built into the structure of the inserts 21.

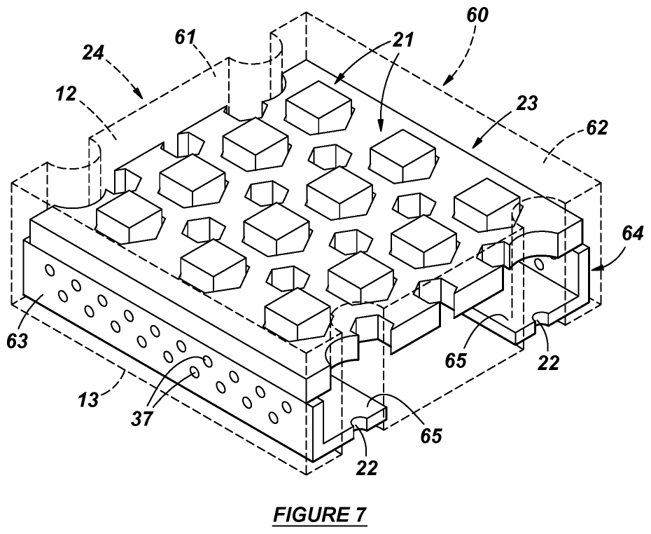

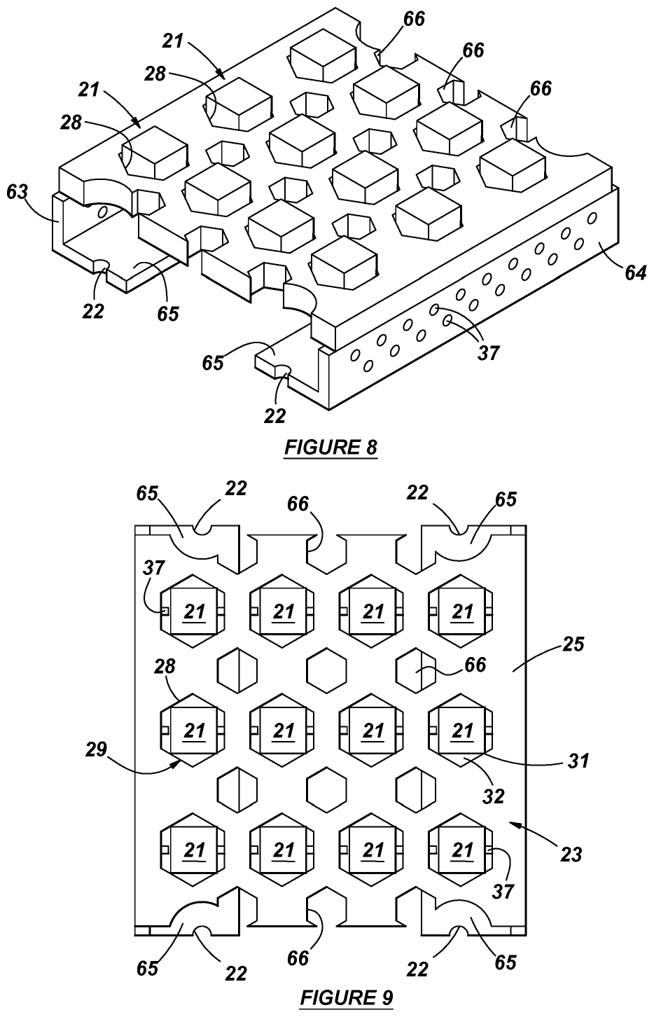

Referring now to FIGS. 7, 8 and 9, yet another preferred embodiment is illustrated. Again, like features described with reference to earlier embodiments have been given the same reference numbers and are not further described here in any detail. FIG. 7 shows a screening panel member module element 60 including an outer injected moulded body 24 having an upper treatment material engagement face 12, a lower or opposite second face 13, and an inner support structure 23 carrying a plurality of hard wear resistant inserts 21. The engagement face 12 includes a planar section 61 and a raised bar or weir section 62 along one edge, The support structure 23 includes a plate section 25, two opposed side walls 63, 64, and inwardly directed tab formations from a lower edge of the side walls 63, 64 located at their lateral ends. The half circular fittings 22 enabling the panel member assembly 60 to be mounted, in use, to a screening machine sub frame are formed in the tab formations 65. The apertures 28 forming the receiving zones 29 for the inserts 21 are configured as shown in earlier embodiments with the inserts 21 also supported on cross rod members 37 acting as stop or support members. It is possible in this embodiment to provide additional openings 66 in the plate section 25 to allow the moulded material forming the outer body structure to pass therethrough. The inserts 21 shown are square inserts as with FIGS. 2, 3 and 4 but could be configured as shown in the other drawings.

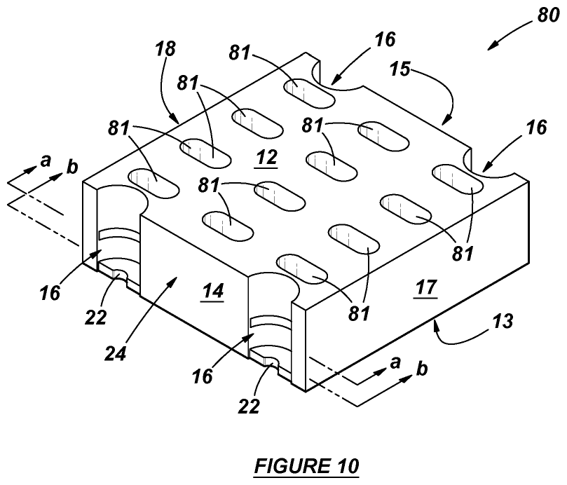

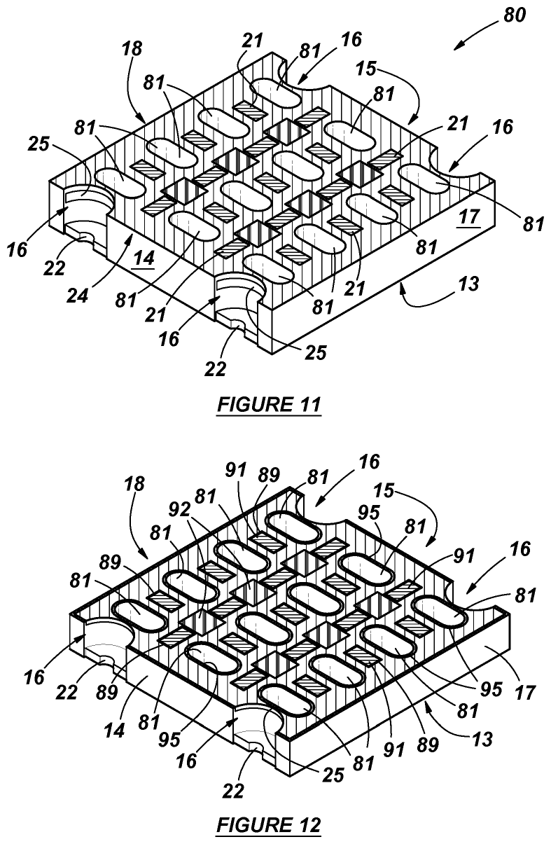

FIG. 10 shows a perspective view of a fourth preferred embodiment of a modular screening panel element 80 in accordance with principles of this disclosure. Like features of earlier described embodiments have been given the same reference numerals and are not further described in detail here. The panel member assembly 80 has an upper treatment material engagement face 12, a lower opposite second face 13, a first pair of opposed side faces 14, 15 defining spaced fixing mount means 16, and a second pair of opposed side faces 17, 18. The modular screening panel element 80 differs from the earlier described embodiments in that an array of spaced through flow apertures or openings 81 are provided extending from the engagement face 12 to and through the opposite lower face 13. The relative size and number of apertures 81 may be variable whereby, in use, a screening panel made up of modular elements 80 will enable treatment material of a certain size range to pass through the apertures 80 and treatment material of a greater size range to not so pass. FIG. 11 shows the screening panel element 80 along section line a-a of FIG. 10 while FIG. 12 shows the screening panel element 80 along section line b-b (FIG. 10).

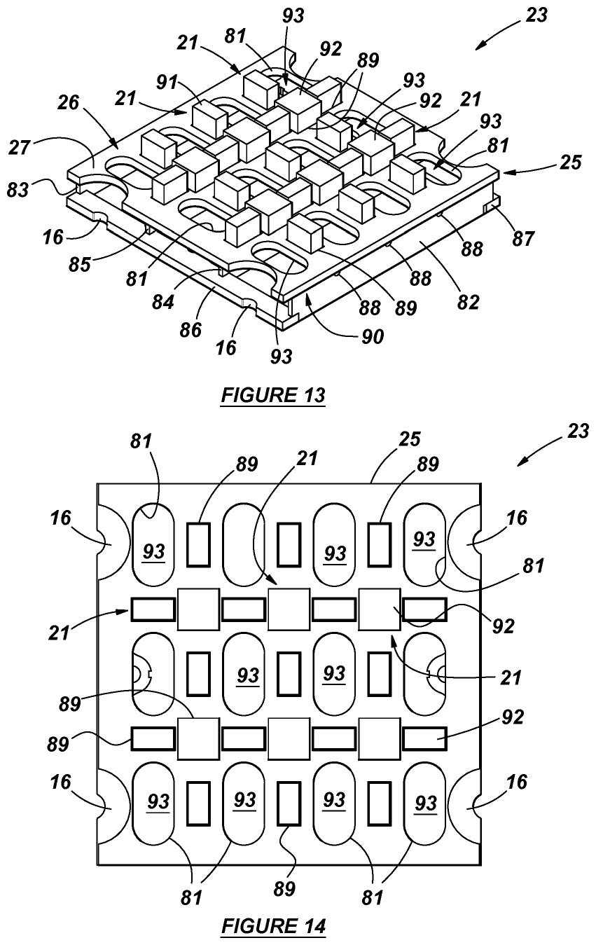

FIGS. 13 and 14 illustrate an internal support structure 23 with installed hard wear resistant inserts 21 located therein similar to the earlier described embodiments. In the finished version of the modular screening panel element (FIG. 10), the support structure 23 and inserts 21 are either fully or partially covered by a moulded cover material 24 forming the outer body. The support structure 23 (FIG. 13) has a plate section 25 with a first upper side 26 with an upper surface 27 facing towards the engagement face 12 of the modular panel member assembly 80. The support structure 23 has side edge panel support strips 82 and 83 with internal support strips 84, 85 running parallel to the side edge panel support strips 82, 83. A pair of lower lateral side support bars 86, 87 connect the respective ends of the strips 82, 83, 84 and 85. Spaced rod support members 88 pass through upper edge zones of the strips 82 to 85 at the level of the lower surface 90 of the plate section 25. The plate section 25 defines a plurality of spaced location apertures or openings 89 for locating each of the hard wear resistant inserts 21, the openings 89 being located either above an upper edge zone of the strips 84, 85 or above the rod members 88, which then act as a stop or support to prevent the inserts 21 passing through the insert location openings 89. The apertures 89 may include a hard surfaced or hard wear resistant metal ring or chute 95 forming the through flow passage (FIG. 12), or the apertures 89 might simply be surfaced by the cover material 24 forming the body 4.

As can be seen in FIGS. 13, 14, the inserts 21 may be of differing configurations such as a rectangular configuration 91 or a square configuration 92. While the drawing illustrates inserts 21 with a uniform cross-section, however, it will be recognised that any of the versions discussed previously with earlier described embodiments could also be used. Similarly, an array of inserts 21 as shown in FIGS. 13, 14 could also be utilised in the earlier described embodiments. It will of course also be recognised that the openings 89 may have zones spaced from the surface of the insert 21 to receive the moulded cover material as with the earlier described embodiments. As can also be seen in FIGS. 13, 14, the plate section 25 also includes an array of openings 93 that correspond in shape and location to the through flow apertures 81 of the panel member assembly 80 (FIG. 10). The apertures 81 and openings 93 are illustrated with a generally oval shape but other configurations and shapes are possible.

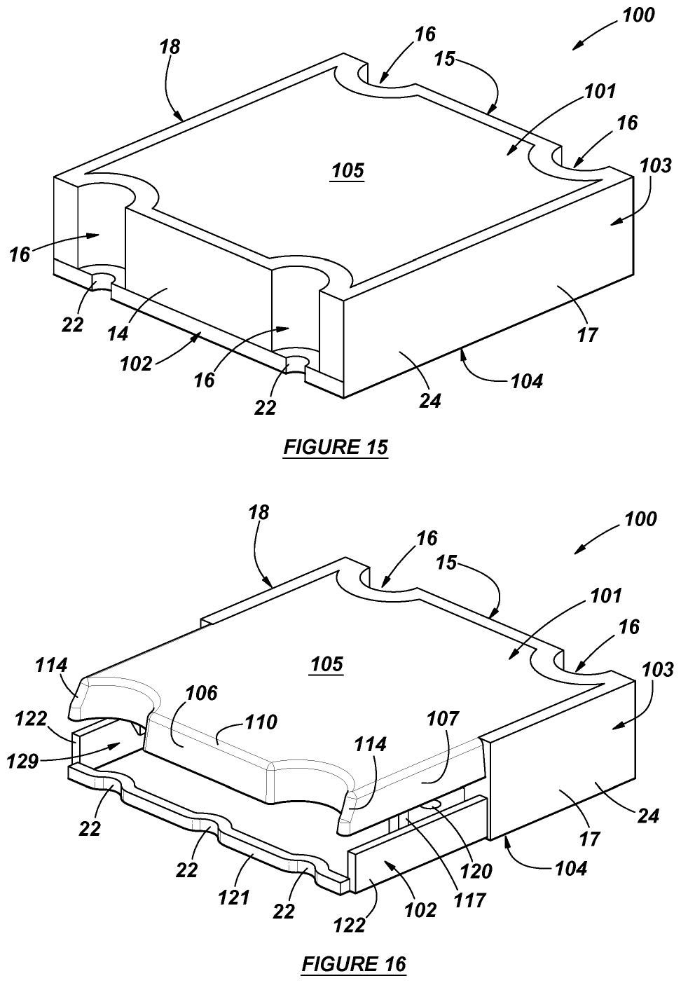

FIG. 15 illustrates a still further preferred embodiment of a panel member assembly 100 including a single hard wear resistant insert 101 produced from a suitable material including those described in previously discussed embodiments. The panel member assembly 100 includes a unitary reinforcing support structure 102 and a body structure 103 made from a mouldable cover material 24 as described with reference to previous embodiments. The body structure 103 has side edge walls 14, 15, 17 and 18, and the panel member assembly has a lower most face 104 made substantially of the cover material 24 and an opposed upper engagement face 105 which, in the illustrated embodiment, is formed mostly of the material of the hard wear resistant insert and a peripheral edge regions of the cover material 24. Of course, in an alternative arrangement, the mouldable cover material might have a portion covering the entire surface area of the engagement face 105. As with previous embodiments, spaced fixed mount means 16 with half circular fittings 22 are provided in the side edge walls 14, 15. While FIG. 1 illustrates an impact type screening panel member assembly, it is equally possible to provide screening apertures extending from the engagement face 105 to the lower face 104 to provide a sieve type screening panel member assembly 100.

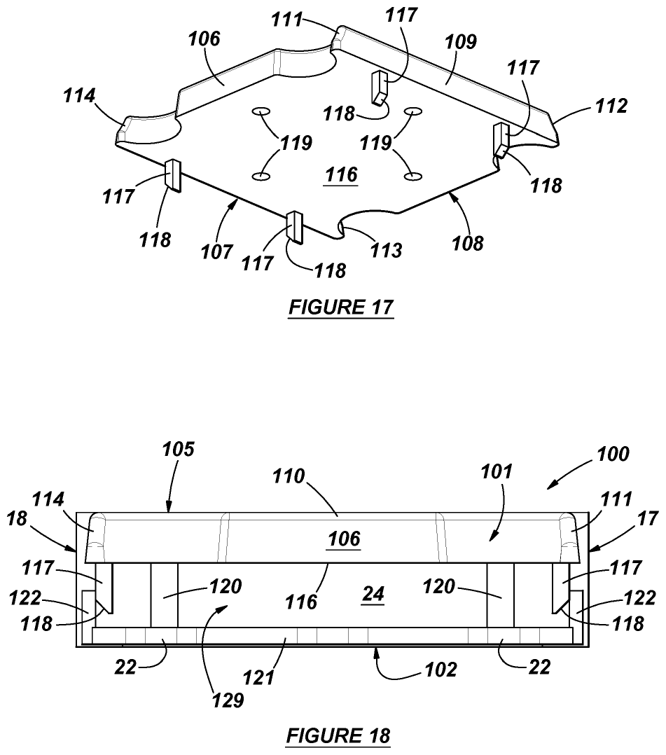

FIGS. 16, 17 and 18 illustrate further internally located features of the panel member assembly 100. The hard wear resistant insert 101 has peripheral side edge walls 106, 107, 108 and 109 each of which are sloped or angled inwardly from the lower face 104 to the upper engagement face 105. A peripheral chamfered edge zone 110 is provided immediately adjacent the upper engagement face 105. In this manner the cover material 24 increases in thickness towards the upper engagement face 105. The corners 111, 112, 113 and 114 also each include sections that are angled inwardly to a greater extent. It is also possible to provide greater recessed regions in the peripheral edge zone 110 if it is desired to further increase the thickness of the mouldable cover material in this region. The hard wear resistant insert 101 has a lower surface 116 of the upper plate section 115 with depending integral projection parts 117, each with an outward sloped end face 118 which act as location means. Recessed zones or bores 119 are also provided in the lower surface 116 to receive and hold distance locating rods or dowels 120. The rods or dowels 120 are conveniently made from an elastomeric or hard rubber compound to provide better bonding with the cover material 24.

The unitary reinforcing support structure 102 includes end bars 121 and spaced side plate members 122 fabricated as a rigid assembly. Further intermediate cross bars connecting the side plate members 122 might also be provided, for example to engage lower ends of the dowel or rod members 120. As can be seen in the drawings, the downward projection parts 117 engage the side plate members 122 to correctly position and hold the hard wear insert 101 on a receiving zone 129 defined between the side plate members 122. The cover material 24 is then applied to secure the panel member assembly as a unitary structure with the elastomeric cover material positioned under the plate section 115 to provide a cushioning effect.

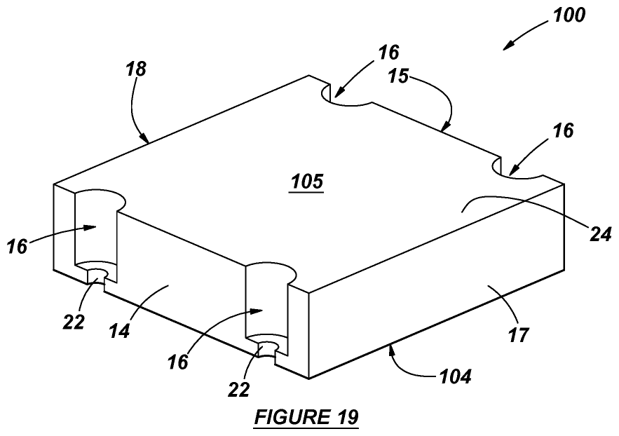

Reference will now be made to still further preferred embodiments illustrated in FIGS. 19 to 22. FIG. 19 shows an embodiment of a panel member assembly 130 having an upper impact type engagement face 105 for engagement, in use, with treatment material. The panel member assembly 130 has a lower surface 104 and side edge walls 14, 15, 17 and 18. Spaced fixing mount means 16, each with half circular fittings 22, are located in each of the side edge walls 14 and 15. In the illustrated embodiment, the outer surfaces of the panel member 130 are made fully or substantially of the mouldable cover material 24, although this is not necessarily essential. For example, it is possible to have at least some of the hard wear resistant insert elements discussed in the following to project partially through the cover material 24 in the engagement face 105 and to form part of the engagement face 105. Further the drawing in FIG. 19 represents the engagement face 105 as planar but alternative configurations are possible including raised spaced bars or projection elements, either solely formed of the mouldable cover material or partially containing part of a hard wear resistant element as is discussed in the following. Still further, FIG. 19 represent an impact type panel member assembly but it is also possible to arrange sieving type through openings passing from the engagement face 105 through the lower face 104 to provide a screening type panel member assembly 130.

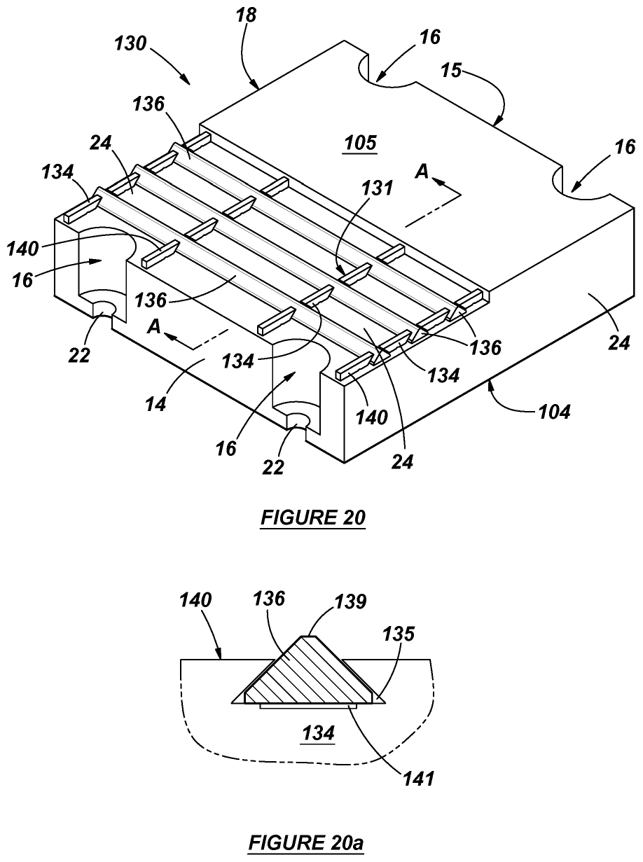

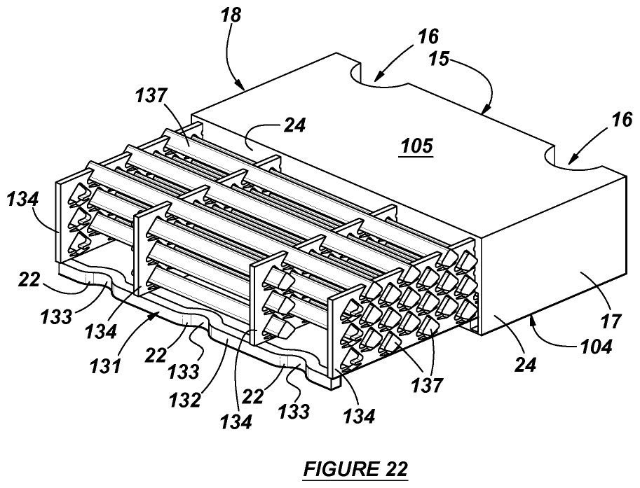

Referring now to FIGS. 20 to 22, details of possible internal constructional features of the panel member assembly 130 are discussed. As can be seen in FIG. 22, a reinforcing unitary frame support structure 131 can be seen once half of the mouldable cover material 24 has been removed to see the internal structural arrangements. The support structure 131 has lower end bar members 132 (only one of which can be seen) each having two spaced outer indentations (or similar) 133 for forming the half circular fittings 22. If considered necessary, further intermediate cross bar member(s) can be provided between the end bar members 132. Also shown in FIG. 22, at least two (and possibly more) upstanding plate members 134 are rigidly secured (for example by welding) to the end bar members 132 and any further intermediate cross bar members, if provided. As represented in the drawings, four such spaced upstanding plate members 134 are provided although it is anticipated that the structure of the unitary reinforcing support structure 131 will vary depending on various operational factors including the number and positioning of the hard wear resistant inserts (discussed below) and whether the panel member assembly 130 is an impact type panel member assembly 130 or whether it is a sieving or screening type panel member assembly 130. It is also anticipated that a panel member assembly might include two or more unitary reinforcing support structures 131 positioned appropriately in a panel member assembly 130.

As is apparent from FIGS. 20 to 22, each of upstanding plate members 134 have a receiving recess, opening or aperture 135 of a particular shape and in a particular array whereby an elongated hard wear resistant insert 136, 137 is held in the recess, opening or aperture 135 extending between at least two (or more) of the upstanding plate members 134. The hard wear resistant insert members 136, 137 are made from materials discussed in relation to previous embodiments and are elongated rod or bar members 136, 137. As illustrated one hard wear resistant insert 136 has a triangular cross-section, and a second version has a diamond cross-section 137 including an elongated vertical diamond configuration (not shown), both of which have a converging peak (viewed in cross-section) facing towards the engagement face 105.

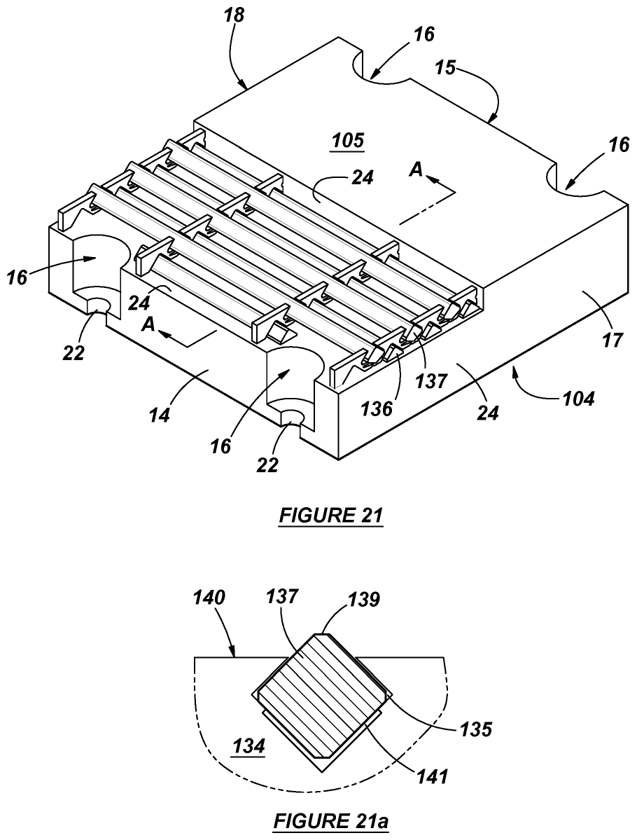

FIG. 20 shows an arrangement where the elongated hard wear resistant inserts 136 are positioned in an upper array where they are in a plane generally parallel to one another. They are also parallel to the side edge walls 14, 15, however, it is possible to have arrangements where the elongated hard wear resistant inserts 136, 137 are arranged parallel to both side edge walls 17, 18. Still further, it is possible to have arrangements wherein an array of a first group or groups of elongated hard wear resistant inserts 136, 137 are arranged parallel to the side edge walls 14, 15 and a second group or groups of elongated hard wear inserts 136, 137 parallel to the side edge walls 17, 18. FIG. 20 represents an arrangement where a first array of hard wear resistant inserts 136 are positioned close to the engagement face 105. This may be the only hard wear resistant inserts in the panel member assembly 130 or alternatively multiple layers of such inserts 136 or 137 may be provided at differing depth levels from the engagement face 105, for example as represented in FIGS. 21 and 22.

FIG. 20a shows a triangular (in cross-section) shaped elongated hard wear resistant insert 136 held within a holding aperture 138 formed in an upstanding plate member 134. In the illustrated embodiment, the peak zone 139 of the insert 136 extends above the top edge 140 of the upstanding plate member 134, however, in other cases, the holding aperture 138 is fully enclosed within the upstanding plate member 134. FIG. 21a represents an alternative configuration where the holding aperture 138 has a different shape to accommodate a differently shaped (in cross-section) elongated hard wear resistant insert 137. As shown in FIGS. 20a and 21a, an opening 141 is provided, at least beneath the inserts 136, 137. While specifically shaped (in cross-section) hard wear resistant inserts 136, 137 are shown in the drawings, it will be recognised that other cross-sectional shapes could be used including, square, rectangular and other polygonal shapes in various relative rotational positions.

The foregoing describes various preferred embodiments of a panel member assembly having essentially a three level wear function provided by, the mouldable cover material, the hard wear resistant inserts of various configurations, and the unitary reinforcing support structure(s) of various designs, each of which provide a level of effective wear resistance capability. Many design features are disclosed with reference to the preferred embodiments but persons skilled in the art will recognise that many other variations and modifications are possible within the scope of the following claims. Further features described or disclosed with reference to one embodiment will generally be usable with regard to other embodiments.

1. A panel member assembly being a screening or impact panel or screening or impact panel module element having an engagement face for engagement with treatment material in use, said panel member assembly further having at least one reinforcing unitary support structure with a first side directed towards said engagement face, said first side defining a receiving zone or zones, the or each said receiving zone being configured to locate an individual hard wear resistant insert, a said hard wear resistant insert located in the or two or more of said receiving zones with at least a portion of the or each said hard wear resistant insert extending towards said engagement face, and a mouldable cover material moulded to said support structure and to said hard wear resistant insert or inserts whereby said mouldable cover material forms, at least in part, said engagement face, while securing said hard wear resistant insert or inserts to said support structure.

2. (canceled)

3. A panel member assembly according to claim 1 wherein the or each said hard wear resistant insert has a first upper surface region facing towards or forming part of said engagement face, a second lower surface region facing away from said engagement face, and a third intermediate side surface region or regions, connecting said first upper and said second lower surface regions, the or each said unitary reinforcing support structure being sufficiently open to permit said mouldable cover material to be moulded to and bond a substantial portion of said second lower surface region and at least part of said side surface region or regions of the or each of said hard wear resistant insert to the or one of a said unitary reinforcing support structure.

4. A panel member assembly according to claim 2 wherein at least some or all of the or each said hard wear resistant insert(s) is substantially fully surrounded by and bonded to said mouldable cover material.

5. (canceled)

6. A panel member assembly according to claim 2 wherein said panel member assembly has a second lower face opposed to said engagement face and a plurality of side edge faces connecting said second lower face to said engagement face, said engagement face having a plurality of spaced screening openings passing through the panel member assembly opening through the second lower face whereby a sieve type screening panel member assembly is provided.

7. (canceled)

8. (canceled)

9. A panel member assembly according to claim 2 wherein the or each said receiving zone is configured whereby a lower region of the or each said receiving zone is substantially open except for first engagement means adapted to engage the hard wear resistant insert located in the receiving zone whereby said first engagement means prevents the engaged hard wear resistant insert from moving in a direction away from said engagement face.

10. A panel member assembly according to claim 2 wherein, some or all of said receiving zone(s) include second engagement means cooperating with a said hard wear resistant insert located in said receiving zone to prevent lateral movement of said hard wear resistant insert in a direction parallel to said engagement face.

11. A panel member assembly according to claim 6 wherein the or each said unitary reinforcing support structure includes spaced openings configured to allow flow of said mouldable cover material along surfaces of the each said hard wear resistant insert towards the second lower surface region of the or each said hard wear resistant insert.

12. A panel member assembly according to claim 1 wherein the or each said support structure includes a plate section facing towards the engagement face and being located in a plane generally parallel to said engagement face, the or each said hard wear resistant insert being located in a said receiving zone formed, at least in part, by a location aperture in said plate section.

13. A panel member assembly according to claim 1 wherein said support structure includes at least a first plate section and a second plate section laterally spaced from one another, each of said first and said second plate sections having a transverse disposition relative to said engagement face whereby an edge region of said first and said second plate sections form part of said engagement face or face towards said engagement face, a said receiving zone or zones being formed in each said first and said second plate section whereby one or more said hard wear resistant insert(s) each being formed as an elongated member extends at least between a selected said receiving zone in each of said first plate section and said second plate section.

14. (canceled)

15. A panel member assembly according to claim 9 wherein said elongated member or members are positioned generally parallel to said engagement face.

16. A panel member assembly according to claim 9 wherein at least two said elongated members are positioned at different distances from said engagement face.

17. A panel member assembly according to claim 9 wherein the or at least one of said elongated members(s) has a cross-sectional shape that dimensionally increases in a direction away from a portion located as part of the engagement face or faces toward the engagement face.

18. A panel member assembly according to claim 12 wherein the or at least one said elongated member has a maximum cross-sectional dimension at a mid-distance from said engagement face and cross-sectionally converges in from said maximum cross-sectional dimension in a direction away from said engagement face.

19. A panel member assembly according to claim 2 wherein a single said hard wear resistant insert engages with said support structure, said single hard wear resistant insert having a wear engagement surface positioned adjacent to or forming part of said engagement face,
resistant insert having a plate section defining on one face said wear engagement surface and on an opposed face, spaced downwardly depending location formations engageable respectively with one of said spaced lateral edge plate means, wear said support structure including spaced lateral edge plate means connected to one another at a location spaced from said engagement face by a connecting wall formation means, said spaced lateral edge plate means defining a said receiving zone, said single hard

20. (canceled)

21. (canceled)

22. A panel member assembly according to claim 1 wherein the support structure has flow apertures to permit said mouldable cover material to flow through the panel member assembly to form the or at least part of the engagement face, a second opposed face of the panel member assembly, and to at least partially surround and bond to the or each said hard wear resistant insert.

23. (canceled)

24. A panel member assembly being a screening or impact panel, or a screening or impact panel module element, that together with other screening or impact panel module elements form a screening or impact deck, the panel member assembly having an engagement face for engagement with treatment material in use, said panel member assembly further having at least one unitary reinforcing support structure with at least one plate section, the or each said plate section having at least one location aperture extending through said plate section, the or each said location aperture forming a receiving zone or discrete spaced receiving zones to locate and hold an individual hard wear resistant insert, a said hard wear resistant insert being located in the or at least some of said receiving zones with at least a portion of the or each said hard wear resistant insert facing towards the engagement face of the panel member assembly, the or each said hard wear resistant insert having an engagement portion or portions engageable with an edge zone of a said location aperture, and a mouldable cover material moulded to said unitary reinforcing support structure and to the or each said hard wear resistant insert whereby said mouldable cover material forms, at least in part, said engagement face, said unitary reinforcing support structure(s) being sufficiently open to provide flow zone(s) for said mouldable cover material to flow either between a said hard wear resistant insert and an edge zone of a said location aperture or extending through said plate section outwardly of and adjacent to a said location aperture whereby said mouldable cover material bonds to and secures at least a lower region of a said hard wear resistant insert to said unitary reinforcing support structure.

25. A panel member assembly according to any one of claim 16 wherein each said hard wear resistant insert has a shape configuration that includes at least a portion of decreasing cross-sectional size towards the engagement face.

26. A panel member assembly according to claim 17 wherein the portion of decreasing cross-sectional size is pyramidal, conical or frustoconical in shape.

27. A method of constructing a panel member assembly being a screening or impact panel, or a screening or impact panel module element, that together with other screening or impact panel module elements form a screening or impact deck having an upper engagement face for engaging treatment material, said method including steps of:
fabricating a unitary reinforcing support structure with a first face and a second opposed face, said support structure defining a receiving zone, or a plurality of spaced receiving zones, the or each said receiving zone being configured to locate and hold an individual hard wear resistant insert;
positioning a said individual hard wear resistant insert in the or at least some of said receiving zones whereby the or each said hard wear resistant insert is partially located within said unitary reinforcing support structure; and
moulding a mouldable cover material to said hard wear resistant insert or inserts positioned in and held by said unitary reinforcing support structure whereby said mouldable cover material secures the or each said hard wear resistant insert to said unitary reinforcing support structure, said mouldable cover material forming at least part of said upper engagement face spaced above said first face of said unitary reinforcing support structure and passing through and encasing said unitary reinforcing support structure to form a second surface below the second opposed face of said unitary reinforcing support structure.

28. A method according to claim 19 wherein the or each said hard wear resistant insert has a first upper end or face extending from the first face of the unitary reinforcing support structure and a second lower end or face, the first upper end or face being connected to the lower end or face by one or more connecting faces, said unitary reinforcing support structure being an open construction whereby said mouldable cover material is moulded to at least a portion or portions of the second lower end or face and the connecting face or faces extending therefrom of the or each said hard wear resistant insert.

29. (canceled)

30. (canceled)
